(19) United States
(12) Patent Application Publication
(10) Pub. No.: US 2005/0240600 A1
(43) Pub. Date: Oct. 27, 2005

(54) Methods, systems, and storage mediums for integrating service request generation systems with a service order control system

(76) Inventor: David A. Hill, Birmingham, AL (US)

Correspondence Address: CANTOR COLBURN LLP, 55 GRIFFIN ROAD SOUTH, BLOOMFIELD, CT, 06002, US

(21) Appl. No.: 10/828,718

(22) Filed: Apr. 21, 2004

(51) Int. Cl. G06F 17/00

(52) U.S. Cl. 707/100

(57) ABSTRACT

Exemplary embodiments include methods, systems, and storage mediums for integrating service request generation systems with a service order control system. The method includes converting data in a service request into an open data format resulting in a converted service request. The method further includes validating the converted service request utilizing user-defined business logic. The validation includes performing accuracy checks and consistency checks of data fields and data within the converted service request. The method further includes resolving any errors and inconsistencies detected from the validation resulting in a validated service request, generating a service order using the validated service request, and transmitting the service order to a service order control application.

### BACKGROUND OF INVENTION

The present invention relates generally to telecommunications services, and more particularly, to methods, systems, and storage mediums for bridging the gap between service request generation systems and a service order control system.

In the telecommunications industry, many incumbent local exchange carriers (ILECs) contract with competitive local exchange carriers (CLECs) to perform services or share performance of services on behalf of their customers. Most ILECs use mechanical processes for generating service orders. This is because requests for service that are received from various independent CLECs are in a variety of different formats and are transmitted via several different communications means. The ILEC, in turn, needs to parse through these disparate requests and manually enter the request data into the service order control system, which processes and tracks the service order until the work requested in the order has been completed. While some automation of service order generation has been attempted, such solutions are not flexible and are expensive to modify.

What is needed, therefore, is a way for telecommunications companies that use service order control systems to generate service orders from service requests received from their business associates.

### SUMMARY OF INVENTION

The above-stated shortcomings and disadvantages are overcome or alleviated by the service order generator of the invention.

Exemplary embodiments include methods, systems, and storage mediums for integrating service request generation systems with a service order control system. Methods include converting data in a service request into an open data format resulting in a converted service request. Methods further include validating the converted service request utilizing user-defined business logic. The validation includes performing accuracy checks and consistency checks of data fields and data within the converted service request. Methods further include resolving any errors and inconsistencies detected from the validation resulting in a validated service request, generating a service order using the validated service request, and transmitting the service order to a service order control application.

The storage medium is encoded with machine-readable computer program code for integrating service request generation systems with a service order control system. The storage medium includes instructions for causing a server to implement a method. Methods include converting data in a service request into an open data format resulting in a converted service request. Methods further include validating the converted service request utilizing user-defined business logic. The validation includes performing accuracy checks and consistency checks of data fields and data within the converted service request. Methods further include resolving any errors and inconsistencies detected from the validation resulting in a validated service request, generating a service order using the validated service request, and transmitting the service order to a service order control application.

Systems include a server executing a service order control application. Systems also include a data repository in communication with the server. The data repository stores service orders. The systems also include a service order generator executing on the server. The service order generator includes a service request normalizer; a rules engine that includes a field validation module and a customer/service validation module; and a service order writer. Systems further include a link to at least one service request source. The service order generator converts data in a service request into an open data format resulting in a converted service request and validates the converted service request utilizing user-defined business logic. The validation includes performing accuracy checks and consistency checks of data fields and data within the converted service request. The service order generator also resolves any errors and inconsistencies detected from the validation resulting in a validated service request, generates a service order using the validated service request, and transmits the service order to a service order control application.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is a block diagram illustrating a network upon which the service order generator may be implemented in exemplary embodiments;

FIG. 2 is a flowchart describing a process for implementing the service order generator in exemplary embodiments;

FIG. 3 is a sample service request converted into XML format by the service order generator in exemplary embodiments;

FIG. 4 is a sample service order in XML created using the XML-formatted service request in exemplary embodiments; and

FIG. 5 is a sample service order formatted in accordance with a service order control application and created by the service order generator in exemplary embodiments.

### DETAILED DESCRIPTION

The service order generator is implementable in any telecommunications environment that uses a service order control system. The service order generator converts service requests in various data formats to an open source format such as XML, applies business logic to the converted data, and creates a service order that is compatible with the telecommunications enterprise's service order control application. Further, the business logic may be modified as new products are introduced into the system and/or new requirements for existing products and services are introduced without requiring any modifications to existing program code thereby eliminating the need for extensive system down time and expensive programming services.

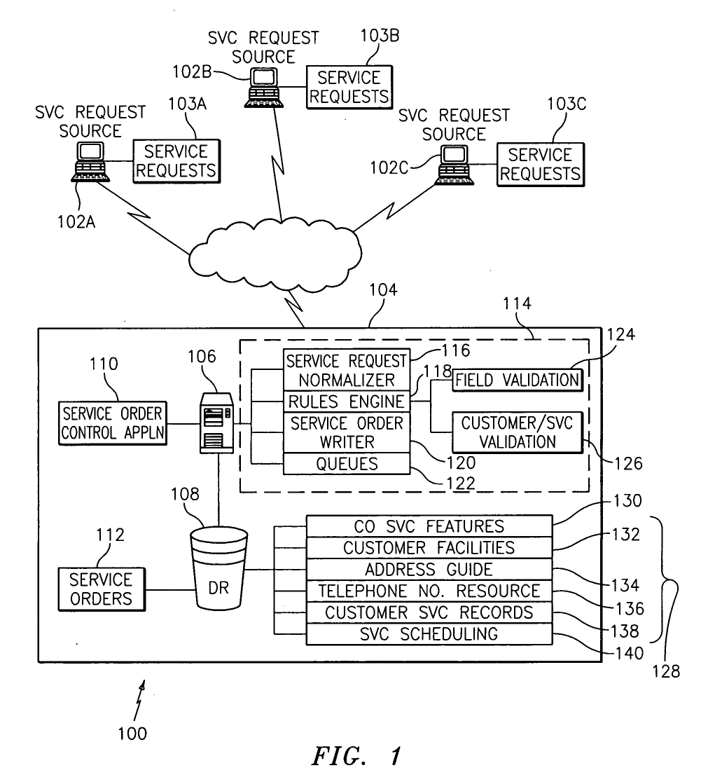

Referring now to FIG. 1, the service order generator system and network environment for implementing the invention is described. System 100 includes three service request source systems 102A-102C in communication with a service order generator host system 104 via a network such as the Internet. For purposes of illustration, service order generator host system 104 represents an incumbent local exchange carrier (ILEC) and service request sources 102A-102C each represent an independent, competitive local exchange carrier (CLEC) that shares a business relationship with the ILEC, such as providing services to customers of the ILEC or performing repairs on network equipment shared with the ILEC. Service request sources 102A-102C each include a computer system such as a general-purpose personal computer, laptop, or other processing device, which generates service requests whenever a customer desires one or more services provided by the CLEC, the ILEC, or a combination of the two entities.

Service order generator host system 104 comprises a server 106 executing the service order generator 114 and a data repository 108. Server 106 may comprise a high-powered computer processor such as a mainframe or similar computing device. Server 106 executes a service order control application 110. Service order control application 110 receives service orders prepared by service order generator 114, processes the service orders, and tracks them through the system. Service order control application 110 may be proprietary to the host system 104 or may be a commercial product such as the Service Order Analysis and Control™ (SOAC) system by Telcordia® Technologies of Piscataway, N.J.

Server 106 executes the service order generator 114, which in turn, comprises modules including a service request normalizer 116, a rules engine 118, a service order writer 120, and one or more queues 122. Service request normalizer 116 (also referred to herein as ‘normalizer’) converts the data in service requests received from service requests sources 102A-102C from their original format to an open data format such as XML. Rules engine 118 performs a variety of tasks via modules 124-126 including data and field validation, error exception routing, and external routing for information gathering. Service order writer 120 formats the data once the rules engine has completed its processing and generates a service order using the formatting recognized by the service order control application 110. Queues 122 receive the data that is routed between the modules described above and provide access the data when one or both modules 124 and 126 are ready to receive it. Queues of data may be stored in cache memory within server 106 for quick and easy access.

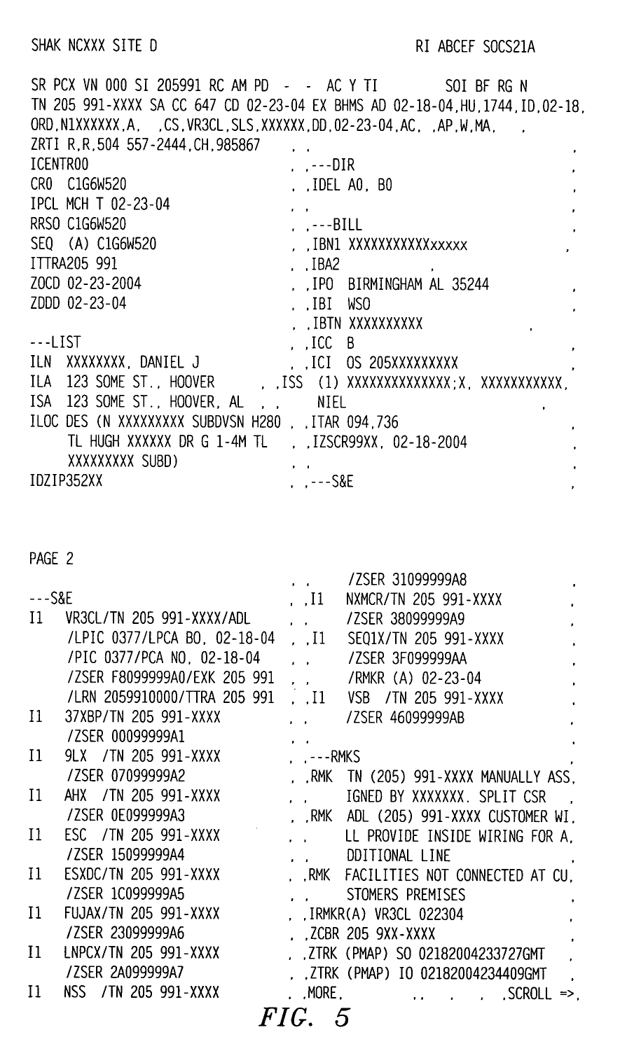

Data repository 108 stores service orders 112 created by the service order generator 114, a sample of which is shown in FIG. 5. Data repository 108 is logically addressable to server 106 and enables service order control application 110 to retrieve service orders 112 for processing. It will be understood by those skilled in the art that data repository 108 and server 106 may comprise a single unit. External sources of information 128 refer to applications, databases, system resources, etc., that are accessible to service order generator 114 as needed. Information sources 128 are queried by service order generator 114 when additional information is required for completing a service order. While information sources 128 are shown as being in direct access to server 106 via data repository 108 within host system 104, it will be understood by those skilled in the art that such information sources may be externally located from host system 104 and may be logically addressable over a communications network such as the Internet.

Central office service features 130 refers to a resource of information relating to available service offerings that are provided by host system 104. Service features 130 may comprise a commercial application and database or may be proprietary to host system 104. For example, central office service features 130 may comprise BellSouth's® Central Office Features File Interface (COFFI). Customer facilities 132 refers to resources that enable validation of customer facilities. For example, one customer facilities resource may comprise BellSouth's® Loop Maintenance Operations System that stores the assignment and selected account information for use by downstream OSS and personnel of host system 104 during provisioning and maintenance activities. Another example of customer facilities resource 132 may include Tecordia's® Trunk Inventory Records Keeping System (TIRKS), as well as BellSouth's® Loop Facilities Assignment and Control Systems.

Address guide 134 refers to a resource used to perform customer address validation. Address guide 134 may be a commercial resource or may comprise a legacy system such as BellSouth's® Regional Street Address Guide that stores street address information for customer validation.

Telephone number resource 136 refers to a resource that stores telephone numbers that are available for reservation and assignment to customers. Telephone number resource 136 may comprise a commercial data warehouse or may be a proprietary system such as BellSouth's® Application for Telephone Number Load, Administration, and Selection (ATLAS).

Customer service records resource 138 refers to a database system for non-access customers and services and is used to obtain customer service record information. Customer service records 138 may be a commercial database or may comprise BellSouth's® Customer Record Information System (CRIS). Customer service records 138 may also include a database resource for customer billing such as BellSouth's® Carrier Access Billing System.

Service scheduling 140 refers to an application that enables host system 104 to schedule dates and times for customer services. Service scheduling 140 may comprise a commercial application or may include BellSouth's® Direct Order Entry Support Application (DSAP) which assists a service representative or carrier agent in negotiating service provisioning commitments for non-designated services and unbundled network elements.

As described above, service request sources 102A-102C each comprise a computer device such as a personal computer, desktop, laptop, or similar device. Service request sources 102A-102C may be in communication with host system 104 by any suitable networking architecture such as the Internet, an Extranet, Intranet, or other network system. Service requests 103A-103C include data and instructions for executing an action on behalf of a customer of the requesting source. For example, in the telecommunications industry, a service request typically includes customer information (e.g., name, address, telephone number, customer identification or codes, etc.), an action requested (e.g., new service, modification to service, equipment installation, upgrade, or removal, etc.), and information relating to the requesting source (e.g., 102A-102C) such as source identification, location, contract or agreement terms, etc. A service request 103A generated from source 102A may be generated using a software tool that is proprietary or may be a commercial off-the-shelf product. Depending upon the tool used, the type of data, data fields, and formatting used by the tool may differ substantially from those utilized by source 102B and 102C. Furthermore, the service requests generated by these sources 102A-102C may not contain all of the data, data fields, and/or formatting elements required by the service order control application. These service requests need to be processed before the service order control application 110 is able to utilize them.

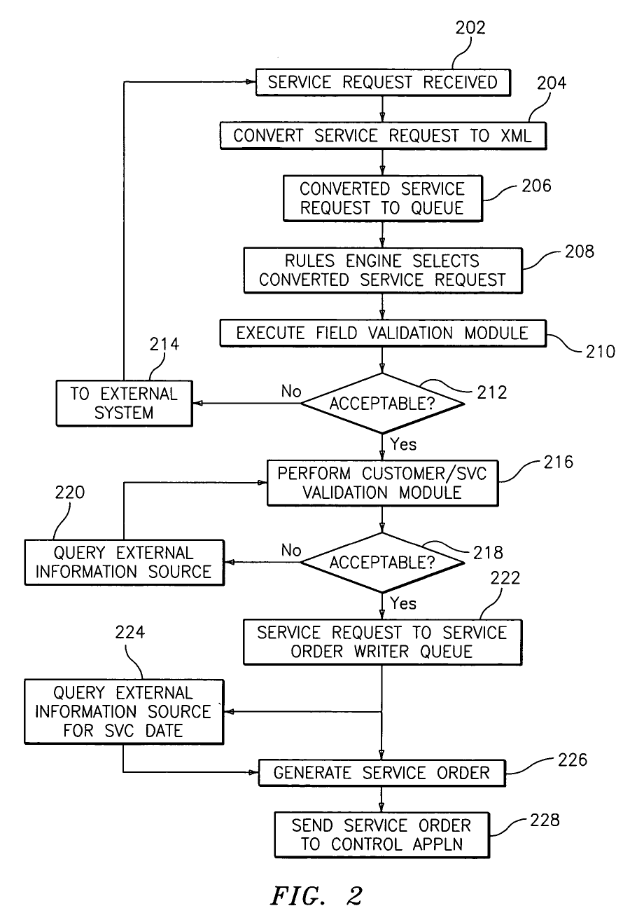

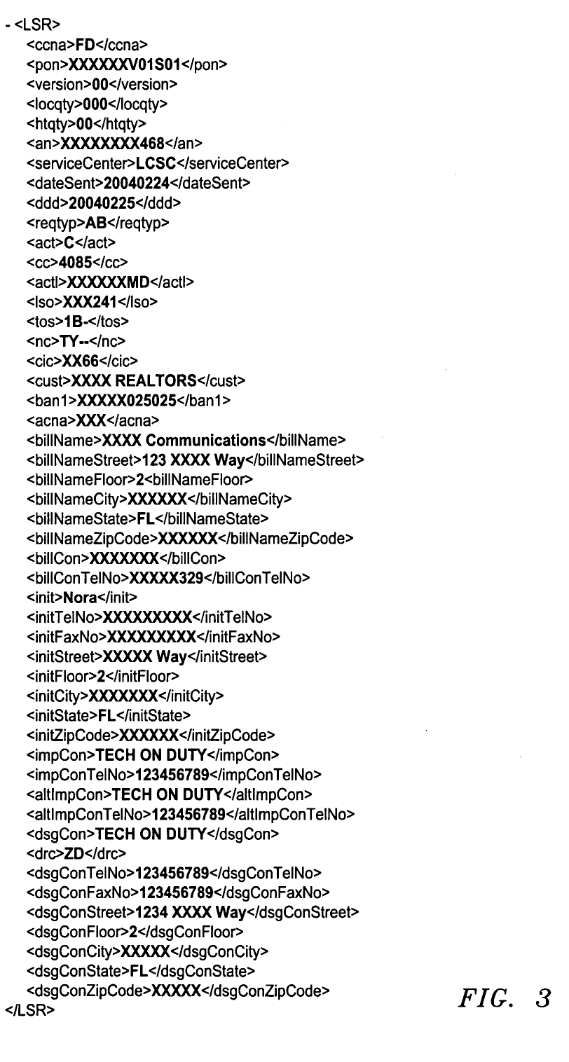

These system elements are described further within the context of FIG. 2 herein. At step 202, service order generator 114 receives a service order request 103 from one of sources 102A-102C via server 106. Normalizer 116 converts the data in the service request to an open format such as XML at step 204. A portion of a sample service request converted to XML is shown generally in FIG. 3. One or more queues 122 may be used to temporarily store requests as they await further processing at step 206. These queues may be used to store requests awaiting any processing steps as described with respect to service order generator 114.

At step 208, rules engine 118 processes the converted service request utilizing modules 124-126 as described herein. Field validation module 124 is initiated at step 210. Field validation module contains business logic for verifying general information common to all service requests such as how to handle a data field that has been left blank and performing a consistency check to ensure that the data entered is consistent with other data within the request. For example, if a service request contains data relating to residential line service but also includes a request for a service exclusive to business lines and/or customers, this inconsistency, or conflict, is flagged for resolution by the field validation module 124. Any number and type of field validation business rules may be adopted by the enterprise executing the service order generator as desired.

At step 212, it is determined whether the converted service request is acceptable (e.g., it conforms to the field validation business rules). If not, rules engine 118 transmits the service request to one of queues 122 where it awaits a conversion back to the original data format of the sending service request source. Once the service request is converted back to its original data format, it is returned to the originating service request source (102A-C) along with a message or flag indicating that a correction is required at step 214. The originating service request source may then retransmit the service request for continued processing and the process returns to step 202.

If the validation performed at step 210 results in an acceptable service request at step 212, the customer/service validation module 126 is initiated at step 216. Similar to the field validation module 124, customer/service validation module 126 includes business logic for analyzing a service request and handling any errors or flags resulting from the analysis. Customer/service validation module 126 identifies any items in the service request that require additional information not provided in the service request. For example, if a request is for a new telephone line, a new telephone number must be generated that meets certain criteria (e.g., local area codes and prefixes). Thus, if execution of customer/service validation module 126 indicates that external information is required at step 218, this information is obtained from an external system (e.g., one or more of resources 130-138) at step 220 and the process returns to step 216. Another example of business logic handled by customer/service validation module 126 includes determining which phone line needs to be involved to fulfill a request for a new phone number, calculating workforce and hardware provisioning systems required to obtain an available date for executing the service in the request, and checking requests for new accounts against existing accounts to ensure that no duplications result from processing a service request. For example, an address validation checks the customer address on the service request to ensure it is correct. Another example might include a feature validation in which a feature requested in a service request is checked against the available features that coincide with the phone line in the request. A phone line validation checks to ensure that the customer's current line will support the requested service. These and other validations may be implemented via customer/service validation module 126

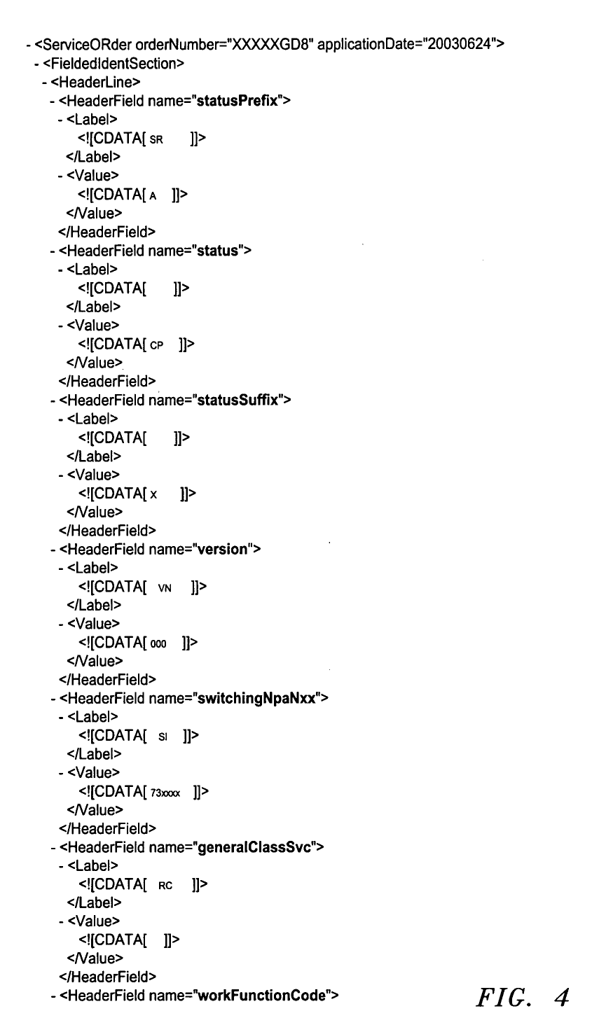

If the execution of customer/service validation module 126 results in an acceptable service request at step 218, the converted service request is ready to be transformed into a service order. A portion of a sample service order is shown in FIG. 4. As shown in FIG. 4, the service order is presented in XML format. The converted service request is sent to service order writer queue 122 at step 222. If applicable, service order writer 120 queries service scheduling resource 140 to identify an available service date for performing the service at step 224. Otherwise, service order writer 120 generates a service order from the converted service request at step 226. The service order is transmitted to service order control application 110 for processing and stored in data repository 108 at step 228. A portion of a sample service order as seen by a user of service control application 110 is shown generally in FIG. 5.

It will be understood by those skilled in the art that the recited steps provided above may be performed in an alternate order. For example, one or more external source queries (as recited in steps 220 and 224) may be conducted simultaneously with, or prior to, redirecting the service request back to the originator as recited in step 214. Thus, it will be understood that the above chronology is described herein for purposes of illustration and is not to be construed as limiting in scope.

The service order generator is implementable in any telecommunications environment that uses a service order control system. The service order generator converts service requests in various data formats to an open source format such as XML, applies business logic to the converted data, and creates a service order that is compatible with the telecommunications enterprise's service order control application. Further, the business logic may be modified as new products are introduced into the system and/or new requirements for existing products and services are introduced without requiring any modifications to existing program code thereby eliminating the need for extensive system down time and expensive programming services.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. A method for integrating service request generation systems with a service order control system, comprising:
converting data in a service request into an open data format resulting in a converted service request;
validating said converted service request utilizing user-defined business logic, said validating including:
performing accuracy checks of data fields and data within said converted service request; and
performing consistency checks of data and data fields within said converted service request;
resolving any errors and inconsistencies detected from said validating resulting in a validated service request;
generating a service order using said validated service request, said service order formatted to comply with formatting utilized by a service order control application; and
transmitting said service order to said service order control application.

2. The method of claim 1, further comprising:
modifying said user-defined business logic to accommodate at least one of:
a new or modified service offered;
a new or modified product offered; and
a new or modified business requirement.

3. The method of claim 1, wherein said performing accuracy checks of data fields and data include:
checking for missing data in said data fields;
checking for incomplete data in said data fields; and
checking for data format errors.

4. The method of claim 1, wherein said performing consistency checks of data and data fields include:
checking a first data field within said converted service request against subsequent data fields within said converted service request, wherein said first data field holds data corresponding to data held in at least one of said subsequent data fields.

5. The method of claim 3, wherein said resolving errors and inconsistencies includes:
converting said converted service request back to its original data format;
transmitting said service request in its original data format back to a corresponding service request source; and
performing at least one of:
flagging said converted service request for correction; and
notifying said corresponding service request source of corrective action to be taken.

6. The method of claim 3, wherein said resolving errors and inconsistencies includes querying an external source of information.

7. The method of claim 6, wherein said external source of information includes at least one of:
a central office service resource storing available service offerings;
a customer facilities resource operable for validating customer facilities, said customer facilities resource including at least one of:
a loop maintenance operations system;
a trunk inventory records keeping system; and
a loop facilities assignment and control system;
an address guide operable for performing address validation, said address guide storing street address information;
a telephone number resource operable for storing telephone numbers that are available for reservation and assignment to customers; and
a customer service records resource operable for obtaining customer service record information.

8. The method of claim 1, wherein said open data format includes extensible markup language.

9. The method of claim 1, wherein said generating a service order includes:
querying a service scheduling resource to identify an available service date for performing a service requested in said validated service requested; and
including a selected service date in said service order.

10. A storage medium encoded with machine-readable computer program code for integrating service request generation systems with a service order control system, said storage medium including instructions for causing a server to implement a method, comprising:
converting data in a service request into an open data format resulting in a converted service request;
validating said converted service request utilizing user-defined business logic, said validating including:
performing accuracy checks of data fields and data within said converted service request; and
performing consistency checks of data and data fields within said converted service request;
resolving any errors and inconsistencies detected from said validating resulting in a validated service request;
generating a service order using said validated service request, said service order formatted to comply with formatting utilized by a service order control application; and
transmitting said service order to said service order control application.

11. A system for integrating service request generation systems with a service order control system, comprising:
a server executing a service order control application;
a data repository in communication with said server;
a service order generator executing on said server, said service order generator including:
a service request normalizer;
a rules engine comprising:
a field validation module; and
a customer/service validation module; and
a service order writer;
a link to at least one service request source;
wherein said service order generator performs:
converting data in a service request received from said at least one service order source into an open data format resulting in a converted service request;
validating said converted service request utilizing user-defined business logic, said validating including:
performing accuracy checks of data fields and data within said converted service request; and
performing consistency checks of data and data fields within said converted service request;
resolving any errors and inconsistencies detected from said validating resulting in a validated service request;
generating a service order using said validated service request, said service order formatted to comply with formatting utilized by a service order control application; and
transmitting said service order to said service order control application.

12. The system of claim 11, wherein said user-defined business logic is modified to accommodate at least one of:
a new or modified service offered;
a new or modified product offered; and
a new or modified business requirement.

13. The system of claim 11, wherein said performing accuracy checks of data fields and data include:
checking for missing data in said data fields;
checking for incomplete data in said data fields; and
checking for data format errors.

14. The system of claim 11, wherein said performing consistency checks of data and data fields include:
checking a first data field within said converted service request against subsequent data fields within said converted service request, wherein said first data field holds data corresponding to data held in at least one of said subsequent data fields.

15. The system of claim 13, wherein said resolving errors and inconsistencies includes:
converting said converted service request back to its original data format;
transmitting said service request in its original data format back to a corresponding service request source; and
performing at least one of:
flagging said converted service request for correction; and
notifying said corresponding service request source of corrective action to be taken.

16. The system of claim 13, wherein said resolving errors and inconsistencies includes querying an external source of information.

17. The system of claim 16, wherein said external source of information includes at least one of:
a central office service resource storing available service offerings;
a customer facilities resource operable for validating customer facilities, said customer facilities resource including at least one of:
a loop maintenance operations system;
a trunk inventory records keeping system; and
a loop facilities assignment and control system;
an address guide operable for performing address validation, said address guide storing street address information;
a telephone number resource operable for storing telephone numbers that are available for reservation and assignment to customers; and
a customer service records resource operable for obtaining customer service record information.

18. The system of claim 11, wherein said open data format includes extensible markup language.

19. The system of claim 11, wherein said generating a service order includes:
querying a service scheduling resource to identify an available service date for performing a service requested in said validated service requested; and
including a selected service date in said service order.

20. The system of claim 11, wherein said service requests are stored in a queue.
